(19) United States
(12) Patent Application Publication
(10) Pub. No.: US 2003/0226448 A1
(43) Pub. Date: Dec. 11, 2003

(54) Stirrer

(76) Inventor: Jessica Cohen, North Hollywood, CA (US)

Correspondence Address: Cahill, von Hellens & Glazer P.L.C., Ste. 155, 2141 E. Highland Avenue, Phoenix, AZ, 85016, US

(21) Appl. No.: 10/449,888

(22) Filed: Jun. 2, 2003

Related U.S. Application Data
(60) Provisional application No. 60/388,028, filed on Jun. 11, 2002.

(51) Int. Cl. A23L 1/00

(52) U.S. Cl. 99/275; 99/279

(57) ABSTRACT

A beverage brewing stirrer has a container with holes in its wall and a sheath snugly surrounding the container and having holes in its wall of the same pattern as the holes in the wall of the container. The sheath is movable on the container between a position in which the holes in the walls of the container and sheath are out of alignment and a position in which the holes are in alignment.

This application claims the benefit of prior filed co-pending U.S. Provisional Application Serial No. 60/388,028 filed Jun. 11, 2002 entitled “Tea Stirrer” by Jessica Cohen.

### TECHNICAL FIELD

This invention is concerned with improving a stirrer which also functions as an infusion device for holding tea for steeping, coffee for brewing or a soluble beverage ingredient.

### BACKGROUND ART

There have been numerous proposals for providing handles on perforate tea containers for swirling the container around in the cup of hot water.

U.S. Pat. No. 4,338,338 granted Jul. 6, 1982 to O. L. Popkes for “Beverage strainers” discloses several versions of a metal foil spoon-like pouch containing tea. Prior to use the perforations in the Popkes pouch are covered by a paper or plastic sheet. For use the sheet is stripped away to permit the hot water to reach and steep the tea. Popkes provides no means for stopping the steeping activity short of completely removing the pouch from the cup of water.

U.S. Pat. No. 5,937,737 granted Aug. 17, 1999 to M. L. Karell for “Personal brewing filter device for coffee, tea and other brewable beverages” discloses devices for squeezing or covering the filter bag to stop brewing with the bag still in the cup. The devices are not suitable, however, for reusing the filter bag for a second cup of beverage.

There continues to be a need for a infusion stirrer which is capable of turning the steeping process “on” or “off” at the will of the beverage consumer.

### SUMMARY OF THE INVENTION

This invention contemplates providing a stirrer with a container portion, preferably an elongated container, for the tea or other beverage substance. The container is sealed except for one or more openings in the wall thereof through which water can enter the container. Surrounding the container in tight engagement therewith is a sheath having one or more openings in its wall. The sheath is movable on the container between one position in which the opening or openings in the wall of the sheath are not aligned with any of the openings in the wall of the container and another position in which the openings are aligned. When it is desired to infuse, or steep, a beverage the sheath is moved to the position in which the sheath opening or openings uncover the container opening or openings. When the steeping has proceeded to the degree desired by the consumer he or she merely moves the sheath to the other position. This stops the steeping process and traps concentrated brew in the container for possible use in brewing a second cup of beverage.

### BRIEF DESCRIPTION OF THE DRAWINGS

The invention is described in greater detail hereinafter by reference to the accompanying drawings wherein:

FIG. 1 is a perspective view of the stirrer of the invention;

FIG. 2 is an exploded view of the components of the stirrer; and

FIG. 3 is an enlarged sectional view of the stirrer taken as indicated by line 3-3 in FIG. 1.

### BEST MODES FOR CARRYING OUT THE INVENTION

The stirrer of this invention is comprised of three principal components, namely, a handle 11, a container 12 and a sheath 13.

The container 12 is adapted to contain tea, or other beverage component, and has a closed end 14 and an open end 15. After the beverage substance has been placed in the container 12 its open end 15 is closed by a plug 16 on the distal end of handle 11. The side wall of the container is provided with one or more and preferably a plurality, or series, of openings 17 to permit the entry of water to the interior of the container for steeping the beverage.

The container 12 is preferably of an elongated tubular configuration of circular cross section as indicated in FIG. 3. However, other cross sectional configurations, such as a square or a hexagon could be employed.

Sheath 13 also has a closed end 18 and an open end 19 and a cross section shaped to snugly receive the container 12. The side wall of the sheath 13 has one or more and preferably a plurality, or series, of openings 20 therein. In the preferred embodiment of the invention illustrated in the drawings the openings 20 in the sheath 13 are in the same pattern as are the openings 17 in the container 12.

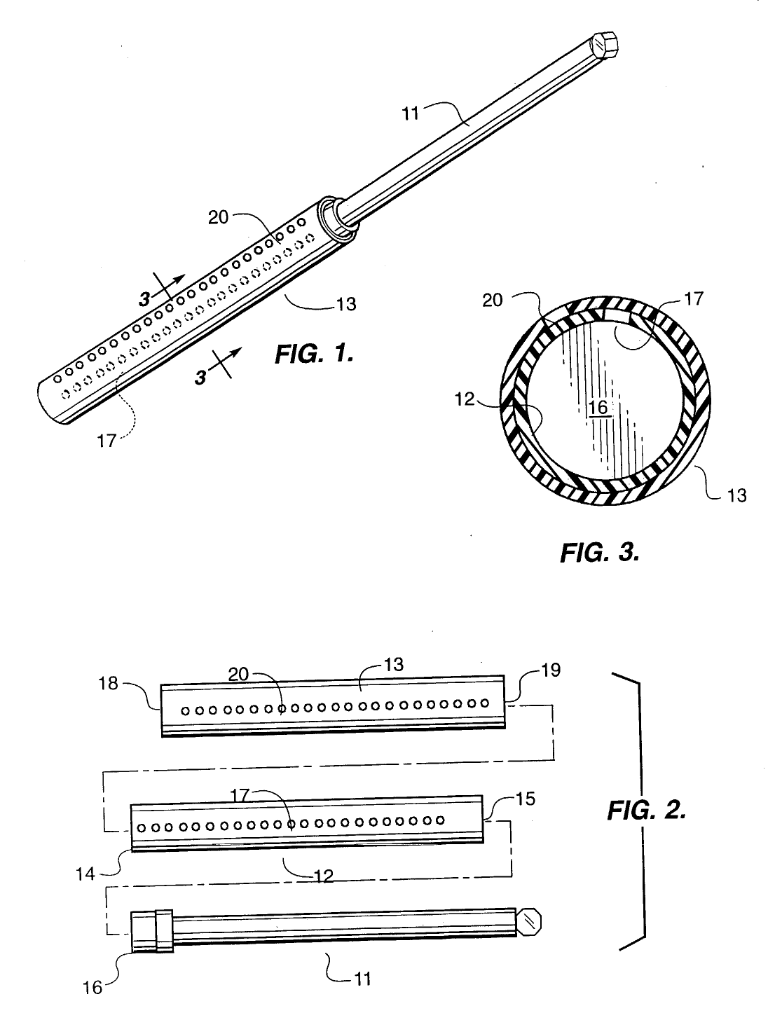

The sheath 13 is movable on the container 12 between one position (as shown in FIGS. 1 and 3) in which the holes 20 in the sheath are not aligned with the openings 17 in the container and another position in which the openings are aligned. Prior to use the sheath is maintained in the nonaligned position to seal the contents of the container. When the consumer desires to brew the beverage the sheath 13 is moved to the aligned openings position to permit water to enter the container. When the beverage has brewed to the extent desired by the consumer, he or she moves the sheath back to the nonaligned position. This stops the brewing process and traps concentrated brew in the container for possible use in brewing another cup of beverage.

The consumer can continue to manipulate the stirrer in the beverage to possibly impart some ritual to the beverage consuming experience.

In the preferred embodiment of the invention illustrated this movement of the sheath 13 relative the container is a rotary motion. However, the movement could be linear with the sheath 13 sliding along the container. Indeed the latter movement would be required for sheaths and containers with cross sectional configurations other than circular.

Because the stirrer is intended to be disposed of after one or two uses it is preferably crafted of inexpensive material. A transparent plastic material is preferred for the container 12 and the sheath 13 so the user can view the contents. If desired the sheath may be tinted to reduce the possible effect of ultraviolet light in the contents.

From the foregoing it should be apparent that this invention provides an improved stirrer which permits the user to turn the brewing process “on” and “off”.

What is claimed is:

1. A beverage brewing stirrer comprising
a container having at least one opening in the wall thereof;
a sheath snugly receiving the container and having at least one opening in the wall thereof,
said sheath being movable on said container between a position in which the at least one opening in the sheath is not in alignment with the at least one opening in the container and another position in which the openings are in alignment, and
a handle.

2. The stirrer of claim 1 in which the said container and the said sheath are of tubular configuration with circular cross sections.

3. The stirrer of claim 1 in which there are a plurality of openings in the wall of said container and there are a plurality of openings in the wall of said sheath patterned like the openings in said container.

4. The stirrer of claim 2 in which there are a plurality of openings in the wall of said container and there are a plurality of openings in the wall of said sheath patterned like the openings in said container.
